(19) United States
(12) Patent Application Publication
(10) Pub. No.: US 2016/0119672 A1
(43) Pub. Date: Apr. 28, 2016

(54) METHODS AND APPARATUS TO IDENTIFY MEDIA USING IMAGE RECOGNITION

(71) Applicant: The Nielsen Company (US), LLC, Schaumburg, IL (US)

(72) Inventors: Rafael Eduardo Alonso, Tampa, FL (US); Mikhail Alperovich, Tampa, FL (US); Chad A. Hage, Clearwater, FL (US)

(21) Appl. No.: 14/523,331

(22) Filed: Oct. 24, 2014

(51) Int. Cl. H04N 21/442; H04N 21/4223; H04N 21/422

(52) U.S. Cl. CPC H04N 21/44222; H04N 21/42204; H04N 21/4223

(57) ABSTRACT

Methods, apparatus, systems and articles of manufacture are disclosed to identify media using image recognition. An example method to identify media includes capturing an image of a media presentation device in response to an input selection to a user control device, the input selection to cause the user control device to control the media presentation device. The example method also includes, in response to identifying an area of interest in the image, generating media identifying information representative of the media based on the identified area of interest.

### FIELD OF THE DISCLOSURE

This disclosure relates generally to audience measurement, and, more particularly, to methods and apparatus to identify media using image recognition.

### BACKGROUND

Audience measurement of media (e.g., any type of content and/or advertisements such as broadcast television and/or radio, stored audio and/or video played back from a memory such as a digital video recorder or a digital versatile disc (DVD), a web page, audio and/or video presented (e.g., streamed) via the Internet, a video game, etc.) often involves collection of media identifying information (e.g., signature(s), fingerprint(s), code(s), tuned channel identification information, time of exposure information, etc.) and people data (e.g., user identifier(s), demographic data associated with audience member(s), etc.). The media identifying information and the people data can be combined to generate, for example, media exposure data indicative of amount(s) and/or type(s) of people that were exposed to specific piece(s) of media.

### BRIEF DESCRIPTION OF THE DRAWINGS

FIG. 1 is a diagram of an example system constructed in accordance with the teachings of this disclosure to identify media using image recognition.

FIG. 2 is a block diagram of an example implementation of the user control device meter of FIG. 1.

FIG. 3 is a block diagram of an example implementation of the audience measurement entity server of FIG. 1.

FIGS. 4 and 5 are flowcharts representative of example machine readable instructions that may be executed to collect media identifying information.

FIG. 6 is a flowchart representative of example machine readable instructions that may be executed to identify media using image recognition.

FIG. 7 is a block diagram of an example user control device meter capable of executing the example machine readable instructions of FIGS. 4 and/or 5 to implement the example user control device meter of FIGS. 1 and/or 2.

FIG. 8 is a block diagram of an example audience measurement entity server capable of executing the example machine readable instructions of FIG. 6 to implement the example audience measurement entity server of FIGS. 1 and/or 3.

### DETAILED DESCRIPTION

Monitoring impressions of media (e.g., television (TV) programs, radio programs, advertisements, commentary, audio, video, movies, commercials, etc.) is useful for generating audience measurement statistics for the media. As used herein, an impression is defined to be an event in which a home or individual is exposed to media (e.g., an advertisement, content, a group of advertisements and/or a collection of content). A quantity of impressions or impression count, with respect to media, is the total number of times homes or individuals have been exposed to the media. For example, in audience metering applications, media identifying information may be detected at one or more monitoring sites when the media is presented (e.g., played at monitored households). In such examples, the collected media identifying information may be sent to a central data collection facility with people meter data identifying person(s) in the audience for analysis such as the computation of an impression count for the media.

Monitoring sites are locations such as, households, stores, places of business and/or any other public and/or private facilities where exposure to, and/or consumption of, media is monitored. For example, at a monitoring site, codes/watermarks and/or signatures/fingerprints from the audio and/or video of the media are captured. The collected codes/watermarks and/or signatures/fingerprints are sent to a central data collection facility for analysis such as the identification of the corresponding media and/or computation of an impression count for the media.

Audio watermarking is a technique used to identify media such as television broadcasts, radio broadcasts, advertisements (television and/or radio), downloaded media, streaming media, prepackaged media, etc. Existing audio watermarking techniques identify media by embedding one or more audio codes (e.g., one or more watermarks), such as media identifying information and/or an identifier that may be mapped to media identifying information, into an audio and/or video component. In some examples, the audio or video component is selected to have a signal characteristic sufficient to hide the watermark. As used herein, the terms “code” or “watermark” are used interchangeably and are defined to mean any identification information (e.g., an identifier) that may be inserted or embedded in the audio or video of media (e.g., a program or advertisement) for the purpose of identifying the media or for another purpose such as tuning (e.g., a packet identifying header). As used herein “media” refers to audio and/or visual (still or moving) content and/or advertisements. To identify watermarked media, the watermark(s) are extracted and used to access a table of reference watermarks that are mapped to media identifying information.

Unlike media monitoring techniques based on codes and/or watermarks included with and/or embedded in the monitored media, fingerprint or signature-based media monitoring techniques generally use one or more inherent characteristics of the monitored media during a monitoring time interval to generate a substantially unique proxy for the media. Such a proxy is referred to as a signature or fingerprint, and can take any form (e.g., a series of digital values, a waveform, etc.) representative of any aspect(s) of the media signal(s)(e.g., the audio and/or video signals forming the media presentation being monitored). A good signature is one that is repeatable when processing the same media presentation, but that is unique relative to other (e.g., different) presentations of other (e.g., different) media. Accordingly, the term “fingerprint” and “signature” are used interchangeably herein and are defined herein to mean a proxy for identifying media that is generated from one or more inherent characteristics of the media.

Signature-based media monitoring generally involves determining (e.g., generating and/or collecting) signature(s) representative of a media signal (e.g., an audio signal and/or a video signal) output by a monitored media device and comparing the monitored signature(s) to one or more references signatures corresponding to known (e.g., reference) media sources. Various comparison criteria, such as a cross-correlation value, a Hamming distance, etc., can be evaluated to determine whether a monitored signature matches a particular reference signature. When a match between the monitored signature and one of the reference signatures is found, the monitored media can be identified as corresponding to the particular reference media represented by the reference signature that with matched the monitored signature. Because attributes, such as an identifier of the media, a presentation time, a broadcast channel, etc., are collected for the reference signature, these attributes may then be associated with the monitored media whose monitored signature matched the reference signature. Example systems for identifying media based on codes and/or signatures are long known and were first disclosed in Thomas, U.S. Pat. No. 5,481,294, which is hereby incorporated by reference in its entirety.

Companies and/or individuals want to understand the reach and effectiveness of the media that they produce and/or sponsor thru advertisements. In some examples, media that is associated with a larger number of exposures may be considered more effective at influencing user behavior as it is seen by a larger number of people than media with a fewer number of exposures. Audience measurement entities (sometimes referred to herein as “ratings entities”) traditionally determine media reach and frequency by monitoring registered panel members. That is, an audience measurement entity enrolls people that consent to being monitored into a panel. In such panelist-based systems, demographic information is obtained from a panelist when, for example, the panelist joins and/or registers for the panel. The demographic information (e.g., race, age or age range, gender, income, home location, education level, etc.) may be obtained from the panelist, for example, via a telephone interview, an in-person interview, by having the panelist complete a survey (e.g., an on-line survey), etc. In some examples, demographic information may be collected for a home (e.g., via a survey requesting information about members of the home). In some examples, demographic information for a panel home may indicate age ranges of members in a panel home without identifying the number of members in each of the age ranges. Thus, the granularity of the collected demographic information may depend on whether the demographic information is collected for a panelist or collected for multiple individuals in a panel home. As used herein, the term “panelist” is generic to both a panelist person and a panel home.

Audience measurement entities such as The Nielsen Company (US), LLC utilize meters to monitor exposure to media. The meter is typically implemented by a device provided to the panelist that collects data of interest concerning exposure to media. For example, the meter may collect data indicating media access activities (e.g., program identification information, source identification information, broadcaster information, time of broadcast information and/or other media identifying information) to which the panelist is exposed. This data is uploaded, periodically or aperiodically, to a data collection facility such as an audience measurement entity server associated with the audience measurement entity. The data collected by a meter is referred to herein as panelist data. Panelist data includes people identifying data and/or activity data. The people identifying data of panelist data (e.g., a panelist identifier such as a telephone number) is advantageous in that it can be linked to demographic information because the panelist has provided their demographics as part of the registration. The activity data collected by the meter can, thus, be associated with that demographic information via, for example, the panelist identifier included in the panelist data transmitted to the audience measurement entity. The people identifying data may then be used to associate demographic information to the activity data. For example, the age of a panelist may be used as part of a statistical calculation to determine an age range of viewers likely to watch a television show.

Typically, an entity such as The Nielsen Company (US), LLC that monitors and/or reports exposure to media operates as a neutral third party. That is, the audience measurement entity does not provide media, for example, content and/or advertisements, to end users. This un-involvement with the media production and/or delivery ensures the neutral status of the audience measurement entity and, thus, enhances the trusted nature of the data it collects. To ensure that the reports generated by the audience measurement entity are useful to the media providers, it is advantageous to be able to identify the media to which the panelists are exposed. Audience measurement entities sometimes partner with media providers to insert or embed codes or watermarks in the media. However, not all media may include the codes/watermarks. Such circumstances present challenges to measuring exposure to the media. For example, media presented via on-line services such as Netflix, Hulu, etc. may not be embedded with codes/watermarks and, thus, crediting such media with an impression is difficult for an audience measurement entity. In some instances where codes/watermarks are included in media, media presentation devices and/or panelist meters may not be capable of extracting the codes/watermarks (e.g., due to computing resource limitations). Alternatively, while signature matching may be utilized to identify media when codes/watermarks cannot be used, in view of the increasingly large amount of media possibilities, signature matching may not be successful and/or practical in some systems. Thus, it may not be possible to identify some media in such prior systems. Unidentified media is typically characterized as “all other tuning” media. Large numbers of all other tuning data may skew the reports generated by the audience measurement entity, resulting in unhelpful information to media providers and others who view the reports.

Example methods, systems and apparatus disclosed herein may be used to identify media by collecting image(s) and/or video(s) of the media as the panelist is exposed to the media (e.g., including media that would previously have been identified as all other tuning media). The collected image(s) and/or video(s) may then be used to identify the media. Examples disclosed herein collect images of media via a meter with an image and/or video capture device (e.g., a camera, a video camera, etc.) integrated with a user device such as a television remote. When a user selects an input (e.g., a button) of the example user device (e.g., uses the remote for channel/volume/input select/other activity), the on-device meter generates an event record of this moment of interest by causing the image and/or video capturing device to capture an image or a set of images (e.g., a video) of the field of view from the user device (e.g., from the remote control). For example, the image and/or video capturing device may be configured to capture an image from the direction in which the user device is pointed. Generally, a user points the user device (e.g., the remote control) at the media presentation device (e.g., a television) when operating the user device, and, thus, the field of view will typically include the media presentation device during such operation.

In some examples, the captured field of view may include sensitive personal data such as, for example, family pictures (e.g., framed family pictures) in the background near the media presentation device. In some examples disclosed herein, the on-device meter may filter the captured image and/or video to identify an area of interest, such as the media presentation device, and crop the image to exclude other areas before uploading the data from the monitored site. For example, certain media providers may use pre-defined interfaces (e.g., graphical user interfaces) while presenting the media. Thus, the on-device meter may analyze the image and/or video of the event record and identify an area of interest that includes the pre-defined interfaces. In some such examples, the on-device meter may discard the portions of the image and/or video not identified as the area of interest (e.g., the background portions). In this manner, the on-device meter protects sensitive user data and reduces the size of the image and/or video, thereby reducing bandwidth usage between the on-device meter and the audience measurement entity and reducing processing demands for image analysis at the audience measurement entity. Alternatively, the on-device meter may obscure or obfuscate areas containing sensitive user data to protect user privacy.

Examples disclosed herein process the area of interest in collected image(s) and/or video(s) of event record(s) to identify the media. In some examples, the on-device meter transmits the image and/or video of the area of interest to an audience measurement entity server for further processing. In some examples, the on-device meter processes the event record(s) and generates an image and/or video signature (e.g., from the area of interest in collected image(s) and/or video(s)). In some such examples, the on-device meter transmits the signature and/or the image/video of the area of interest to the audience measurement entity server. The audience measurement entity server may then use the signature and/or image/video of the area of interest to identify the media. For example, the audience measurement entity server may compare one or more characteristics of the signature and/or image/video of the area of interest to libraries of reference signatures, logo(s), screenshots, image captures and/or other media identifying elements useful for identifying the media.

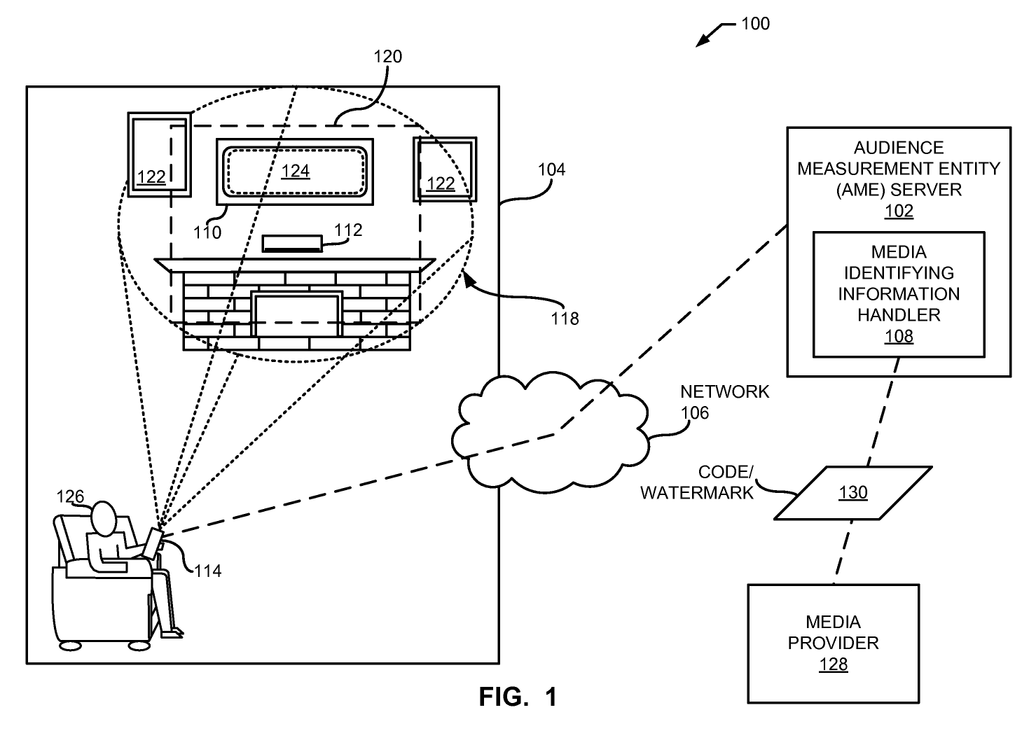

FIG. 1 is an illustration of an example environment 100 in which examples disclosed herein may be implemented to identify media using image recognition. The example environment 100 of FIG. 1 includes an example audience measurement entity (AME) server 102, an example media exposure site 104 and an example media provider 128. In some examples, the AME server 102 is implemented using multiple devices. For example, the AME server 102 may include disk arrays or multiple workstations (e.g., desktop computers, workstation servers, laptops, etc.) in communication with one another. In the illustrated example, the AME server 102 is in selective communication with the media exposure site 104 via one or more wired and/or wireless networks represented by network 106.

The example network 106 may be implemented using any suitable wired and/or wireless network(s) including, for example, one or more data buses, one or more Local Area Networks (LANs), one or more wireless LANs, one or more cellular networks, the Internet, etc. As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events.

In the illustrated example of FIG. 1, an audience measurement entity (AME) operates and/or hosts the example AME server 102. The AME of the illustrated example is an entity that monitors and/or reports exposure to media and/or develops ratings and/or other statistics for media. The AME server 102 of the illustrated example is a server and/or database that collects and/or receives media identifying information related to media presented in the media exposure site 104. The AME of the illustrated example is a neutral entity that is not involved with the distributing and/or production of media. Alternatively, the AME could be affiliated with the media provider 128, another media provider, an advertiser, etc.

As discussed above, the example media provider 128 may engage the AME to collect and/or monitor information related to media associated with the media provider 128. For example, the media provider 128 may want to compare the performances of three distinct pieces of media (e.g., media A, media B and media C) to one another, to other media and/or to an expected or desired performance (e.g., reach and/or frequency).

In the illustrated example of FIG. 1, the AME server 102 includes an example media identifying information handler 108 to facilitate inserting reference media identifying information into media to enable the AME server 102 to identify the media using image recognition. In the illustrated example, the media identifying information handler 108 provides codes/watermarks 130 to the media provider 128 for inserting (e.g., embedding) into media. For example, the media identifying information handler 108 may provide the media provider 128 an example code A to include (e.g., insert, embed, etc.) in a first piece of media (e.g., media A), an example code B to include in a second piece of media (e.g., media B), and an example code C to include in a third piece of media (e.g., media C).

In the illustrated example, the media identifying information handler 108 generates codes that are later included in media provided by the media provider 128. For example, the codes may be inserted by audio encoding (sometimes referred to as audio watermarking) in which the codes are inserted into the audio portion of the media. In some examples, the code is masked so that the code is inaudible to human hearers of the audio. In other examples, the code may be audible to certain human listeners. The codes that are embedded in the audio may be of any suitable length. Any suitable technique for mapping information (e.g., a channel identifier, a station identifier, a broadcaster identifier, a content creator identifier, a content owner identifier, a program identifier, a time stamp, a broadcast identifier, etc.) to the code(s) may be utilized. In the illustrated example, the codes/watermarks (e.g., the example codes A, B and/or C) are included in the media before and/or during presentation (e.g., broadcasting, transmission, streaming, playback of recorded media, etc.). When the media is presented on a media presentation device (e.g., played through a television, a radio, a computing device, a cellular telephone, etc.), a meter (e.g., an example meter 112 and/or an example user control device meter 114) in the area of the presentation (e.g., the media exposure site 104) is exposed not only to the media, but also to the code(s) embedded in the media. In some examples, the code is extracted and registered (e.g., stored in a data structure such as a lookup table), and used by the media identifying information handler 108 to facilitate identifying registered media.

Although, in the above example, the AME 102 provides the codes to the media provider 128, in a more common implementation and in the industry today, the AME provides the broadcasters with coding equipment to use at the point of transmission rather than the codes. The coding equipment inserts a code (e.g., inserts a station identifier and a time stamp) every two seconds. This code (station identifier and time stamp) can then be used to look up the corresponding media based on a broadcast schedule provided by the media provider/broadcaster. Other implementations are also possible.

In the illustrated example of FIG. 1, the example media exposure site 104 includes a media presentation device 110, the meter 112 and the user control device meter 114 for collecting media identifying information. In the illustrated example of FIG. 1, the media exposure site 104 is a room of a household (e.g., a room in a home of a panelist such as the home of a “Nielsen family”) that has been statistically selected to develop media ratings data for a geographic location, a market, and/or a population/demographic of interest. In the illustrated example, one or more persons of the household have registered with the AME (e.g., by agreeing to be a panelist) and have provided their demographic information to the audience measurement entity as part of a registration process to enable the AME to associate the demographics with viewing activities (e.g., media exposure) detected in the media exposure site 104.

In the illustrated example of FIG. 1, the media presentation device 110 (e.g., a television) may be in communication with a digital video recorder (DVR) and/or a digital versatile disc (DVD) player. In some examples, additional and/or alternative types of media presentation devices are monitored such as, for example, a radio, a computer display, a video game console and/or any other communication device able to present media to one or more individuals via any past, present or future medium(s), and/or protocol(s) (e.g., broadcast television, analog television, digital television, satellite broadcast, Internet, cable, etc.).

The meter 112 of the illustrated example collects codes and/or signatures for the purpose of media identification and also collects people identifying information by, for example, requiring audience members to log in periodically, using facial recognition, etc. Alternatively, the meter 112 may include one or more additional devices for collecting media identifying information and/or people identifying data.

The user control device meter 114 (e.g., a universal television remote control that is enhanced with audience measurement functionality as explained below) is provided in the example media exposure site 104 to control the media presentation device 110 and meter media presented on the media presentation device 110. An audience member 126 interacts with the user control device meter 114 to control operation of the media presentation device 110 and/or other devices in the environment. In the illustrated example of FIG. 1, the user control device meter 114 generates event record(s) at moments of interest. As used herein, a moment of interest refers to when detected user activity corresponds to media exposure. For example, the user control device meter 114 may generate an event record when the audience member 126 uses the user control device meter 114 to change a channel tuned by the media presentation device 110 and/or an accompanying device (e.g., a set top box (STB)), adjust the volume level of the media presentation device 110 and/or an accompanying device, select an input of the media presentation device 110 and/or an accompanying device, etc. The user control device meter 114 then associates the event records with media identifying information.

The example user control device meter 114 of FIG. 1 collects image(s) (e.g., two-dimensional image data) of the field of view from the user control device meter 114 to include in an event record. In the illustrated example of FIG. 1, the user control device meter 114 collects image(s) (e.g., snapshot(s)) of media presented via the media presentation device 110, generates media identifying information (e.g., signatures, fingerprints, etc.) based on the collected image(s), and provides the media identifying information to the AME server 102 to identify the media.

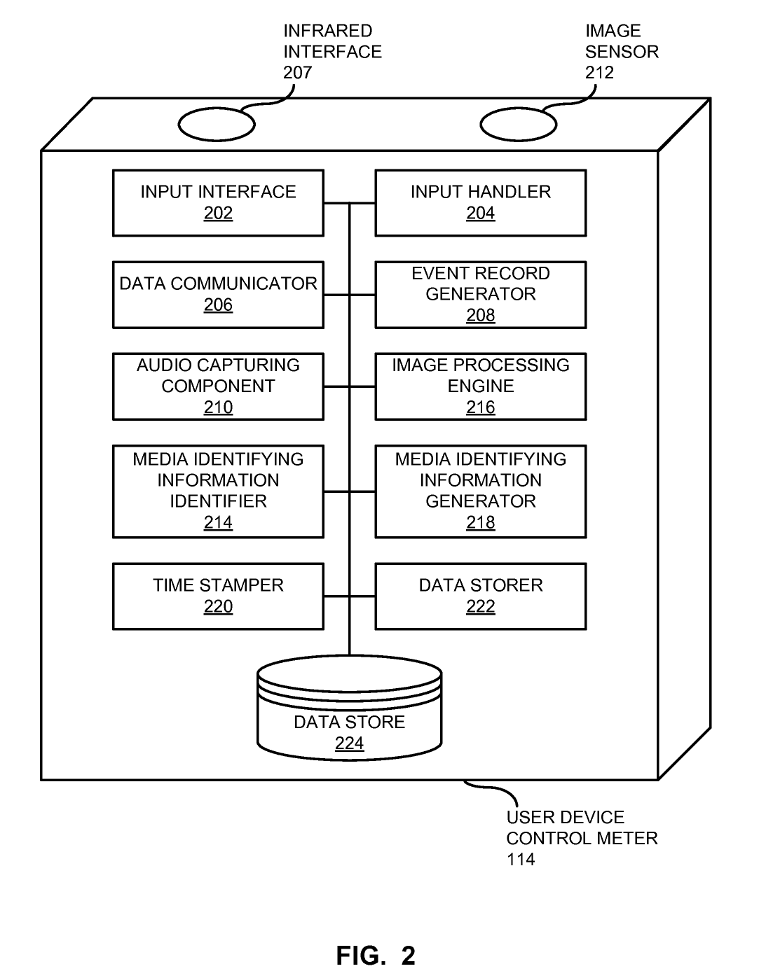

In the illustrated example, the user control device meter 114 also collects audio data presented in the media exposure site 104. The example user control device meter 114 includes the collected audio data in the generated event record. As explained below in connection with FIG. 2, if the event record of the media presented in the media exposure site 104 includes embedded media identifying information such as codes, watermarks and/or tuning information, the user control device meter 114 attempts to collect the embedded media identifying information. In the illustrated example, if the event record of the media presented in the media exposure site 104 does not include embedded media identifying information and/or the user control device meter 114 is unable to detect the embedded media identifying information, the user control device meter 114 resorts to generating media identifying information (e.g., signatures, fingerprints, etc.) based on the collected image(s) in the event record. In other words, in such an example, the user control device meter 114 generates media identifying information only if the user control device meter 114 is unable to detect embedded media identifying information in the event record. In other examples, the user control device meter 114 attempts to collect first media identifying information (e.g., codes, watermarks and/or tuning information) included (e.g., embedded) in the event record of the presented media and generates second media identifying information (e.g., signatures, fingerprints, etc.) based on collected image(s) in the event record.

In the illustrated example of FIG. 1, when the audience member 126 selects an input (e.g., selects a button) on the example user control device meter 114, the example user control device meter 114 generates an event record of a moment of interest by capturing an image(s) (e.g., using an image capturing device such as a camera, a video camera, etc.) of an example field of view 118 from the user control device meter 114. For example, when an audience member 126 operates the user control device meter 114, the audience member 126 points the user control device meter 114 in a direction towards the media presentation device 110 and the operation is detected as a moment of interest. The example user control device meter 114 of FIG. 1 generates an event record of the moment of interest utilizing the image 120 and the audio data. The user control device meter 114 captures an example image 120 within the field of view 118 and captures audio data (e.g., using an audio capturing component) in the event record.

In the illustrated example of FIG. 1, the field of view 118 of the collected image 120 also includes sensitive personal data such as framed family pictures 122 in the background near the media presentation device 110. The example user control device meter 114 of FIG. 1 processes the image 120 to identify an area of interest 124 such as the display of the media presentation device 110. For example, as described in conjunction with FIG. 2, the user control device meter 114 of the illustrated example includes an image processing engine 216 to identify graphical user interfaces used by some media providers. The media provider 128 may display an indication to aid in the identification of the area of interest (e.g., may display a red border on the media presented by the media presentation device 110). In some such examples, the user control device meter 114 identifies the indication in the image 120 to identify the area of interest 124.

The example user control device meter 114 of FIG. 1 discards portions of the image 120 not identified as the area of interest 124. In some examples, the user control device meter 114 may further process the area of interest 124 to remove unintended features included in the area of interest 124. For example, the user control device meter 114 may capture the image 120 at the same time as an audience member crosses in-front of the field of view 118 and, thereby, a body part of the audience member may overlap the area of interest 124. In some such examples, the user control device meter 114 may modify the area of interest 124 to exclude the body part. In the illustrated example, the user control device meter 114 collects a stream of images (e.g., more than one frame of image data). Thus, frames including the body part can be dropped in favor of other, less obstructed frames, from the stream of collected images and/or portions of multiple images may be combined to reconstruct an unobstructed image.

As explained above, audience measurement entities may use media identifying information to identify media and credit the media with an impression. In the illustrated example of FIG. 1, the user control device meter 114 generates media identifying information from the area of interest 124. For example, the user control device meter 114 may generate a signature (e.g., a fingerprint, a sequence of alphanumeric characters, etc.) uniquely representing the area of interest 124.

As described in detail below, the example user control device meter 114 of FIG. 1 communicates media identifying information to the example AME server 102 of FIG. 1. The example user control device meter 114 of FIG. 1 periodically and/or aperiodically transmits a message having a payload of media identifying information of an event record (e.g., embedded codes, watermarks and/or tuning information collected from the presented media and/or signatures, fingerprints, etc. generated by the user control device meter 114 based on collected image(s)), to the AME server 102. Additionally or alternatively, the example user control device meter 114 transmits the media identifying information to the meter 112 (e.g., in response to queries from the meter 112, which periodically and/or aperiodically polls the user control device meter 114).

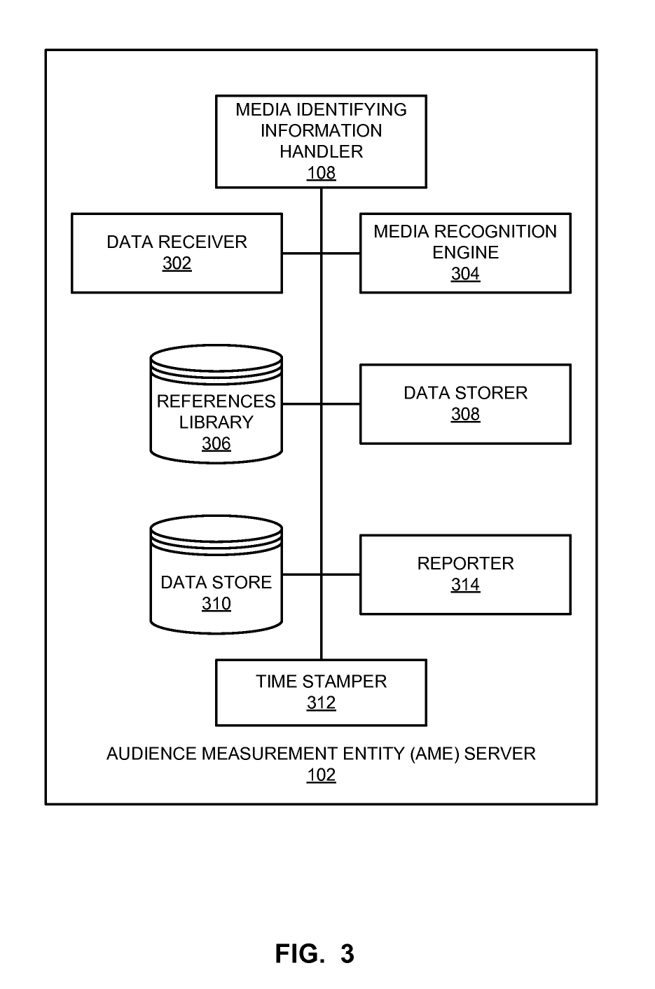

In some examples, the user control device meter 114 includes a media recognition engine such as the example media recognition engine 304 described in greater detail below in connection with FIG. 3. In some such examples, the user control device meter 114 provides data regarding identified media to the example AME server 102 in addition to or alternatively to the media identifying information.

In the example of FIG. 1, the user control device meter 114 is a dedicated audience measurement unit provided by the audience measurement entity for collecting and/or analyzing data (e.g., media identifying information) from, for example, the media exposure site 104. In such examples, the user control device meter 114 includes its own housing, processor, memory, image sensor, audio capturing component(s) and software to collect media identifying information and/or perform desired audience measurement function(s). In some such examples, the user control device meter 114 is adapted to communicate with the meter 112 via a wired and/or wireless connection.

In other examples, the user control device meter 114 is a software meter installed in a device owned by a panelist such as a smart phone, a tablet, a laptop, etc. at the time of manufacture. In some other examples, the panelist may install the software meter on their device. For example, a panelist may download the software meter to the device from a network, install the software meter via a port (e.g., a universal serial bus (USB)) from a jump drive provided by the audience measurement entity, install the software meter from a storage disc (e.g., an optical disc such as a Blu-ray disc, Digital Versatile Disc (DVD) or CD (compact Disk)), or by some other installation approach. Executing such a software implementation of the user control device meter 114 on the panelist's equipment reduces the costs of installation by relieving the audience measurement entity of the need to supply hardware to the monitored household.

The example media identification system of FIG. 1 can be implemented in additional and/or alternative types of media exposure sites such as, for example, a room in a non-statistically selected household, a theater, a restaurant, a tavern, a store, an arena, etc. For example, the media exposure site 104 may not be associated with a panelist of an audience measurement study.

FIG. 2 is a block diagram of an example implementation of the user control device meter 114 of FIG. 1. The example user control device meter 114 of the illustrated example is an enclosure that includes an example input interface 202, an example input handler 204, an example data communicator 206, an example infrared interface 207, an example event record generator 208, an example audio capturing component 210, an example image sensor 212, an example media identifying information identifier 214, an example image processing engine 216, an example media identifying information generator 218, an example time stamper 220, an example data storer 222 and an example data store 224. In some examples, the user control device meter 114 includes a power source (e.g., one or more rechargeable batteries) to provide power to the user control device meter 114.

In the illustrated example, the user control device meter 114 includes the input interface 202 to enable an audience member (e.g., the example audience member 126 of FIG. 1) to operate the user control device 114. For example, the input interface 202 may include physical buttons and/or virtual buttons (e.g., via a touch screen) for the audience member 126 to select.

The example user control device meter 114 includes the input handler 204 to identify user activity (e.g., when the example audience member 126 is interacting with the user control device meter 114). For example, when a moment of interest occurs, the input handler 204 obtains the input selection (e.g., from the input interface 202), processes the input selection and initiates the event record generator 208. In the illustrated example, the input handler 204 does not initiate the event record generator 208 when, for example, intermediate input selections are obtained. For example, when the audience member 126 is selecting numerical inputs to change the channel, the input handler 204 may not initiate the event record generator 208 until an ENTER selection is made, until a threshold amount of time has passed after the last selection, etc. In some examples, when the input handler 204 detects input selections, the input handler 204 initiates the event record generator 208, regardless of the type of the input selection (e.g., all input selections are qualifying input selections to initiate the event record generator 208). In some examples, the input handler 204 initiates the event record generator 208 for as long as the input handler 204 detects an input selection, for a predetermined time period after interaction with the input interface 202 is detected or interaction with the input interface 202 stops, until the input handler 204 detects a change in orientation of the user control device meter 114 (e.g., the audience member 126 moves the user control device meter 114 to face away from the media presentation device 110), etc.

The example data communicator 206 of the illustrated example of FIG. 2 is implemented by a wireless communicator to enable the user control device meter 114 to communicate with a network interface. For example, the data communicator 206 may be implemented by a wireless interface, an Ethernet interface, a cellular interface, a Bluetooth interface, an infrared interface, etc. In the illustrated example, the input handler 204 communicates the processed input selections to the media presentation device 110 and/or the meter 112 via an infrared interface 207 of the data communicator 206. The example user control device meter 114 may communicate with the AME server 102 of FIG. 1 via a wireless interface of the data communicator 206.

In the illustrated example of FIG. 2, the user control device meter 114 includes the event record generator 208 to generate event records. In the illustrated example, the event record generator 208 is triggered by the input handler 204 when the input handler 204 determines an input selection is a moment of interest. In the illustrated example, the event record generator 208 generates an event record by associating image data and/or audio data with the moment of interest. For example, the event record generator 208 may prompt the image sensor 212 to capture image(s) of the field of view 118 and/or the audio capturing component 210 to capture audio data of the media presented in the media exposure site 104 at the moment of interest. In the illustrated example, the event record generator 208 stores the generated event records in the data store 224. In some examples, the event record generator 208 includes the input selection information determined by the input handler 204 in the generated event record. In the illustrated example, the event record generator 208 sends the event records to the audience measurement entity 102 to identify the media.

The example audio capturing component 210 of the illustrated example is implemented by one or more directional microphones capable of collecting audio data of the media presented in the media exposure site 104. In the illustrated example, the audio capturing component 210 is triggered by the event record generator 208 when the event record generator 208 generates an event record. In some examples, the audio data collected by the audio capturing component 210 is recorded in the corresponding event record in the data store 224.

The example image sensor 212 of the illustrated example is implemented by a camera capable of capturing (e.g., taking) images of the field of view 118 of the user control device meter 114 (e.g., from the user control device meter 114). In the illustrated example of FIG. 2, the image sensor 212 is triggered by the event record generator 208 when the event record generator 208 generates an event record. In the illustrated example, the image sensor 212 captures one or more images 120 representing the field of view 118 from the user control device meter 114. In some examples, the images 120 captured by the image sensor 212 are recorded with the corresponding event record in the data store 224. In the illustrated example, the images 120 may be saved as a bitmap image (bmp) and/or any other image format such as a Joint Photographic Experts Group (JPEG) format, a Tagged Image File Format (TIFF), a Portable Network Graphics (PNG) format, etc.

In the illustrated example, the user control device meter 114 includes the media identifying information identifier 214 to identify media identifying information included in an event record (e.g., embedded media identifying information). The example media identifying information identifier 214 of FIG. 2 retrieves one or more event records from the data store 224 to process. For example, the media identifying information identifier 214 may parse the audio data and/or the image data of the event record for embedded media identifying information (e.g., codes, watermarks, etc.). The example media identifying information identifier 214 provides the embedded media identifying information to the event record generator 208 to associate with the corresponding event record. In the illustrated example, the media identifying information identifier 214 prompts the image processing engine 216 to process the images 120 included in the event record and the media identifying information generator 218 to generate media identifying information when the media identifying information identifier 214 is unable to detect embedded media identifying information. In other examples, the media identifying information identifier 214 prompts the image processing engine 216 to process the images 120 included in the event record and the media identifying information generator 218 to generate media identifying information regardless of whether or not the media identifying information identifier 214 detects embedded media identifying information in the media presented in the media exposure site 104.

The example user control device meter 114 includes the image processing engine 216 to process the images 120 included in event records. The image processing engine 216 processes the images 120 captured by the image sensor 212 and attempts to identify patterns and/or shapes (e.g., graphical user interfaces, pre-defined interfaces, icons, logos, etc.) within the image 120. In the illustrated example, the image processing engine 216 utilizes image recognition to compare the identified patterns and/or shapes to known patterns and/or shapes to identify, for example, the area of interest 124 within the image 120. For example, the image processing engine 216 may include and/or access a library (e.g., a data structure) storing known patterns and/or shapes indicative of a particular user interface (e.g., a program guide), a particular type of media, a particular media provider, a particular media presentation device, etc. In some examples, the image processing engine 216 discards portions of the image 120 when the portions are not identified as known patterns and/or shapes (e.g., the identified patterns and/or shapes are not the same as or nearly the same as known patterns and/or shapes, do not satisfy a similarity threshold, etc.), and/or may discard portions of the image 120 when the portions match (e.g., the same or nearly the same, satisfy a similarity threshold, etc.) known patterns and/or shapes indicative of areas of non-interest.

In some examples, the images 120 captured by the image sensor 212 and/or the area of interest 124 may be processed to identify unintended features that indicate sensitive personal data in the background near the area of interest 124. For example, the image processing engine 216 may identify a family picture (e.g., using facial recognition), a media presentation device stand, overlapping (e.g., covering) features such as body parts, pets, etc. and discard the unintended (e.g., background) features. For example, the image processing engine 216 may identify unintended features or areas of non-interest by comparing components and/or portions of the images 120.

In some examples, the image sensor 212 may capture a stream of images (e.g., more than one frame of image data) in a burst. For example, when the input handler 204 initiates generating event records, the image sensor 212 may capture ten “burst-mode” frames. In some such examples, the image processing engine 216 may process each of the frames in the stream of images to identify a frame that satisfies a preferred quality (e.g., a minimum quality determined by the media provider 128). In some examples, the image processing engine 216 may combine one or more of the frames in the stream of images to improve the quality of the image 120. In the illustrated example, the image processing engine 216 processes the frames in the stream of images prior to identifying the area of interest 124. In some examples, the image processing engine 216 may process the frames in the stream of images while attempting to identify the area of interest 124. In some examples, the image processing engine 216 may detect an unintended feature based on a comparison of an identified shape through the frames in the stream of images. For example, the image processing engine 216 may detect a static rectangle (e.g., a family portrait) in the area of interest 124 based on a comparison of characteristics of the rectangle through the frames in the stream of images. For example, the image processing engine 216 may detect no change in the rectangle through the frames in the stream of images and determine the rectangle is an unintended feature (e.g., a family portrait).

In the illustrated example, the image processing engine 216 discards the portions of the images 120 not identified as the area of interest 124. For example, the image processing engine 216 may discard unintended features identified in the image(s), may discard the frames in the stream of images that do not satisfy the preferred quality, etc. In this manner, the user control device meter 114 protects sensitive user data and reduces the size of the images 120 for processing, thereby reducing processing demands for image analysis.

The user control device meter 114 of FIG. 2 includes the example media identifying information generator 218 to generate media identifying information (e.g., signatures, fingerprints, etc.) from the area of interest 124 identified by the image processing engine 216. The media identifying information generator 218 generates a unique signature representative of the area of interest 124. In some examples, the media identifying information generator 218 generates signatures using, for example, feature extraction and/or feature encryption. For example, the media identifying information generator 218 may divide the area of interest 124 into n-sections, calculate a centroid of each section (e.g., based on the color and/or position of each pixel to give a weighted value to each section), and combine the centroid values to form a signature. However, any other past, present and/or future method for generating media identifying information (e.g., signatures, fingerprints, etc.) uniquely representative of the area of interest 124 may additionally or alternatively be used. In the illustrated example, the media identifying information generator 218 provides the generated media identifying information to the event record generator 208 to associate with the corresponding event record.

The example time stamper 220 of FIG. 2 includes a clock and a calendar. The example time stamper 220 associates a time period (e.g., 1:00 a.m. Central Standard Time (CST) to 1:01 a.m. (CST) and a date (e.g., Jan. 1, 2014) with media identifying information (e.g., signatures, fingerprints, etc.) generated by the media identifying information generator 218 by, for example, appending the period of time and the date information to an end of the data.

In the illustrated example of FIG. 2 the example data storer 222 stores the event records generated by the event record generator 208, the audio data collected by the audio capturing component(s) 210, the one or more images 120 captured by the image sensor 212, the embedded media identifying information identified by the media identifying information identifier 214, the images 120 processed by the image processing engine 216, the media identifying information generated by the media identifying generator 218 (e.g., signatures, fingerprints, etc.) and/or the time stamps generated by the time stamper 220. In some examples, the data storer 222 may append a panelist identifier to the media identifying information.

The example data store 224 of FIG. 2 may be implemented by any storage device and/or storage disc for storing data such as, for example, a volatile memory (e.g., Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example data store 224 may include one or more double data rate (DDR) memories, such as DDR, DDR2, DDR3, mobile DDR (mDDR), etc. The example data store 224 may additionally or alternatively include one or more mass storage devices such as, for example, hard drive disk(s), compact disk drive(s), digital versatile disk drive(s), etc. Furthermore, the data stored in the data store 224 may be in any data format such as, for example, binary data, comma delimited data, tab delimited data, structured query language (SQL) structures, etc. While in the illustrated example the data store 224 is illustrated as a single database, the data store 224 may be implemented by any number and/or type(s) of databases.

While an example manner of implementing the user control device meter 114 of FIG. 1 is illustrated in FIG. 2, one or more of the elements, processes and/or devices illustrated in FIG. 2 may be combined, divided, re-arranged, omitted, eliminated and/or implemented in any other way. Further, the example input interface 202, the example input handler 204, the example data communicator 206, the example infrared interface 207, the example event record generator 208, the example audio capturing component 210, the example image sensor 212, the example media identifying information identifier 214, the example image processing engine 216, the example media identifying information generator 218, the example time stamper 220, the example data storer 222, the example data store 224 and/or, more generally, the example user control device meter 114 of FIG. 1 may be implemented by hardware, software, firmware and/or any combination of hardware, software and/or firmware. Thus, for example, any of the example input interface 202, the example input handler 204, the example data communicator 206, the example infrared interface 207, the example event record generator 208, the example audio capturing component 210, the example image sensor 212, the example media identifying information identifier 214, the example image processing engine 216, the example media identifying information generator 218, the example time stamper 220, the example data storer 222, the example data store 224 and/or, more generally, the example user control device meter 114 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example input interface 202, the example input handler 204, the example data communicator 206, the example infrared interface 207, the example event record generator 208, the example audio capturing component 210, the example image sensor 212, the example media identifying information identifier 214, the example image processing engine 216, the example media identifying information generator 218, the example time stamper 220, the example data storer 222 and/or the example data store 224 is/are hereby expressly defined to include a tangible computer readable storage device or storage disk such as a memory, a digital versatile disk (DVD), a compact disk (CD), a Blu-ray disk, etc. storing the software and/or firmware. Further still, the example user control device meter 114 of FIG. 1 may include one or more elements, processes and/or devices in addition to, or instead of, those illustrated in FIG. 2, and/or may include more than one of any or all of the illustrated elements, processes and devices.

FIG. 3 is a block diagram of an example implementation of the audience measurement entity (AME) server 102 of FIG. 1 that may facilitate identifying media using image recognition. The example AME server 102 of the illustrated example includes the example media identifying information handler 108, an example data receiver 302, an example media recognition engine 304, an example references library 306, an example data storer 308, an example data store 310, an example time stamper 312 and an example reporter 314. As discussed above, the AME server 102 includes the example media identifying information handler 108 to facilitate inserting embedded media identifying information (e.g., codes, watermarks, etc.) into media to enable the AME server 102 to identify the media after presentation. For example, the media identifying information handler 108 may instruct the media provider 128 to insert the code/watermark 130 into media. In the illustrated example, the media identifying information handler 108 records the code/watermark 130 in the example references library 306 for use when attempting to identify media at a later time.

In the illustrated example of FIG. 3, the AME server 102 includes the example data receiver 302 to facilitate communication with user devices (e.g., the user control device meter 114 of FIGS. 1 and/or 2). For example, the data receiver 302 may obtain media identifying information (e.g., embedded media identifying information detected by the example media identifying information identifier 214 or media identifying information generated by the example media identifying information generator 218 of FIG. 2) from the user control device meter 114 and/or the meter 112 of FIG. 1.

In the illustrated example of FIG. 3, the AME server 102 includes the example media recognition engine 304 to attempt to identify media using the media identifying information provided by the user control device meter 114. As described above, the example media identifying information handler 108 stores reference media identifying information in the references library 306. In the illustrated example, the media recognition engine 304 compares media identifying information received from the user control device meter 114 to the reference media identifying information stored in the references library 306. For example, the media recognition engine 304 may compare a signature generated by the user control device meter 114 based on an identified area of interest 124 in an image 120 of an event record to a reference signature generated by the AME server 102. When the media recognition engine 304 identifies a match (e.g., the media identifying information obtained from the user control device meter 114 and/or the meter 112 is the same or nearly the same as the reference media identifying information stored in the references library 306), the media recognition engine 304 credits (or logs) impressions to the identified media (e.g., the media corresponding to the reference media identifying information). For example, the media recognition engine 304 may record a media impression entry in the data store 310 and/or list an identification of the corresponding media (e.g., via one or more media identifiers) in a data structure. In addition, the media recognition engine 304 may append a time stamp from the example time stamper 312 indicating the date and/or time when the media identifying information is received by the AME server 102. This time stamp may be in addition to a time stamp received from the user control device meter 114 identifying the media exposure time. In some examples, the media recognition engine 304 may characterize the media impression with quality of impression information. For example, an audience member 126 changing channels or increasing volume levels of the media presentation device 110 may be more likely to be paying attention to the media presented in the media exposure site 104 than when the audience member 126 is lowering the volume level of the media presentation device 110. In some such examples, the media recognition engine 304 may characterize a media impression associated with changing channels or increasing volume levels with a higher quality of impression than a media impression associated with lowering volume levels.

In some examples, the media recognition engine 304 may be unable to identify the media associated with the media identifying information. For example, the user control device meter 114 may not have detected a code/watermark in presented media or the user control device meter 114 and/or was unable to generate a signature from captured images 120. In some examples, the media recognition engine 304 may be unable to match a signature obtained from the user control device meter 114 and/or the meter 112 to reference media identifying information stored in the references library 306. For example, the area of interest 124 used by the media identifying information generator 218 of FIG. 2 to generate a signature may have included unintended features (e.g., a photograph), thereby generating a signature that may not be representative of the media presented and, thus, matching to reference media identifying information may not be possible. In the illustrated example, when the media recognition engine 304 is unable to identify media, the media recognition engine 304 categorizes the media as “all other tuning data.”

The example references library 306 of FIG. 3 may be implemented by any storage device and/or storage disc for storing data such as, for example, a volatile memory (e.g., Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example references library 306 may include one or more double data rate (DDR) memories, such as DDR, DDR2, DDR3, mobile DDR (mDDR), etc. The example references library 306 may additionally or alternatively include one or more mass storage devices such as, for example, hard drive disk(s), compact disk drive(s), digital versatile disk drive(s), etc. Furthermore, the data stored in the references library 306 may be in any data format such as, for example, binary data, comma delimited data, tab delimited data, structured query language (SQL) structures, etc. While in the illustrated example the references library 306 is illustrated as a single database, the references library 306 may be implemented by any number and/or type(s) of databases.

In the illustrated example of FIG. 3, the example data storer 308 stores media identifying information received from the data receiver 302 and/or the media impression entry recorded by the media recognition engine 304.

The example data store 310 of FIG. 3 may be implemented by any storage device and/or storage disc for storing data such as, for example, a volatile memory (e.g., Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example data store 310 may include one or more double data rate (DDR) memories, such as DDR, DDR2, DDR3, mobile DDR (mDDR), etc. The example data store 310 may additionally or alternatively include one or more mass storage devices such as, for example, hard drive disk(s), compact disk drive(s), digital versatile disk drive(s), etc. Furthermore, the data stored in the data store 310 may be in any data format such as, for example, binary data, comma delimited data, tab delimited data, structured query language (SQL) structures, etc. While in the illustrated example the data store 310 is illustrated as a single database, the data store 310 may be implemented by any number and/or type(s) of databases.

The example time stamper 312 of FIG. 3 includes a clock and a calendar. The example time stamper 312 associates a time period (e.g., 1:00 a.m. Central Standard Time (CST) to 1:01 a.m. (CST)) and a date (e.g., Jan. 1, 2014) with each media impression entry recorded by the media recognition engine 304 by, for example, appending the period of time and the date information to an end of the data in the media impression entry, including the media impressions identified as all other tuning data.

In the illustrated example of FIG. 3, the reporter 314 generates reports based on the media impression entries recorded (e.g., logged) in the data store 310. In some examples, the reports are presented to the media provider 128 and/or other entities. The reports may identify aspects of media usage such as, for example, how many impressions the media received and demographics associated with those impressions. For example, the reports may indicate a number of impressions of media grouped by demographic groups for a time period.

While an example manner of implementing the audience measurement entity (AME) server 102 of FIG. 1 is illustrated in FIG. 3, one or more of the elements, processes and/or devices illustrated in FIG. 3 may be combined, divided, re-arranged, omitted, eliminated and/or implemented in any other way. Further, the example media identifying information handler 108, the example data receiver 302, the example media recognition engine 304, the example references library 306, the example data storer 308, the example data store 310, the example time stamper 312, the example reporter 314 and/or, more generally, the example audience measurement entity (AME) server 102 of FIG. 1 may be implemented by hardware, software, firmware and/or any combination of hardware, software and/or firmware. Thus, for example, any of the example media identifying information handler 108, the example data receiver 302, the example media recognition engine 304, the example references library 306, the example data storer 308, the example data store 310, the example time stamper 312, the example reporter 314 and/or, more generally, the example audience measurement entity (AME) server 102 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example media identifying information handler 108, the example data receiver 302, the example media recognition engine 304, the example references library 306, the example data storer 308, the example data store 310, the example time stamper 312 and/or the example reporter 314 is/are hereby expressly defined to include a tangible computer readable storage device or storage disk such as a memory, a digital versatile disk (DVD), a compact disk (CD), a Blu-ray disk, etc. storing the software and/or firmware. Further still, the example audience measurement entity (AME) server 102 of FIG. 1 may include one or more elements, processes and/or devices in addition to, or instead of, those illustrated in FIG. 3, and/or may include more than one of any or all of the illustrated elements, processes and devices.

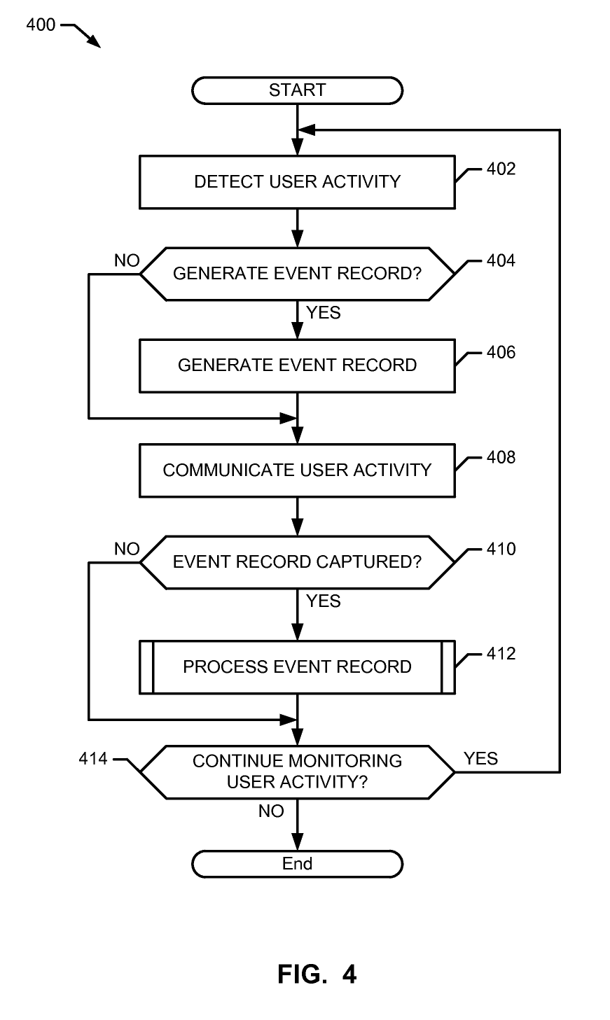

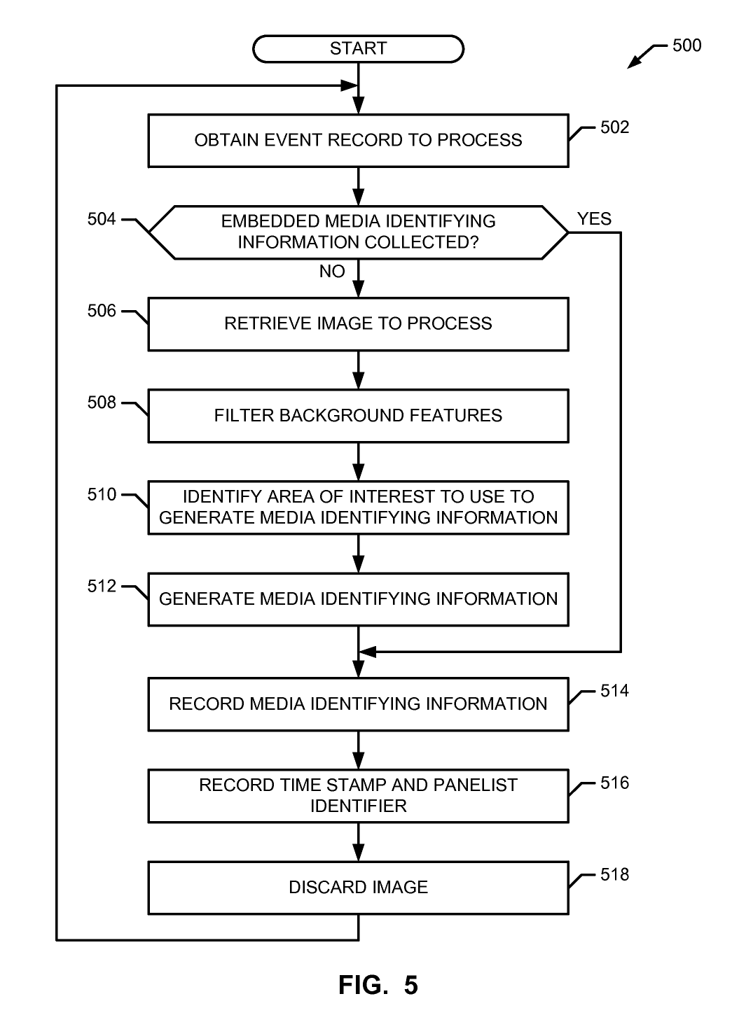

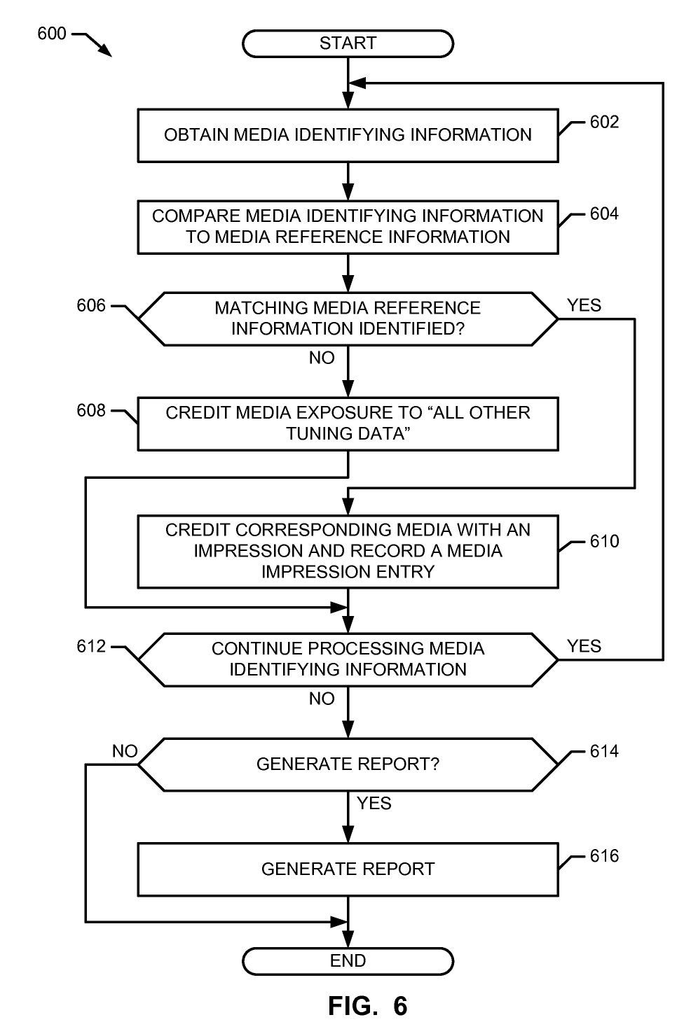

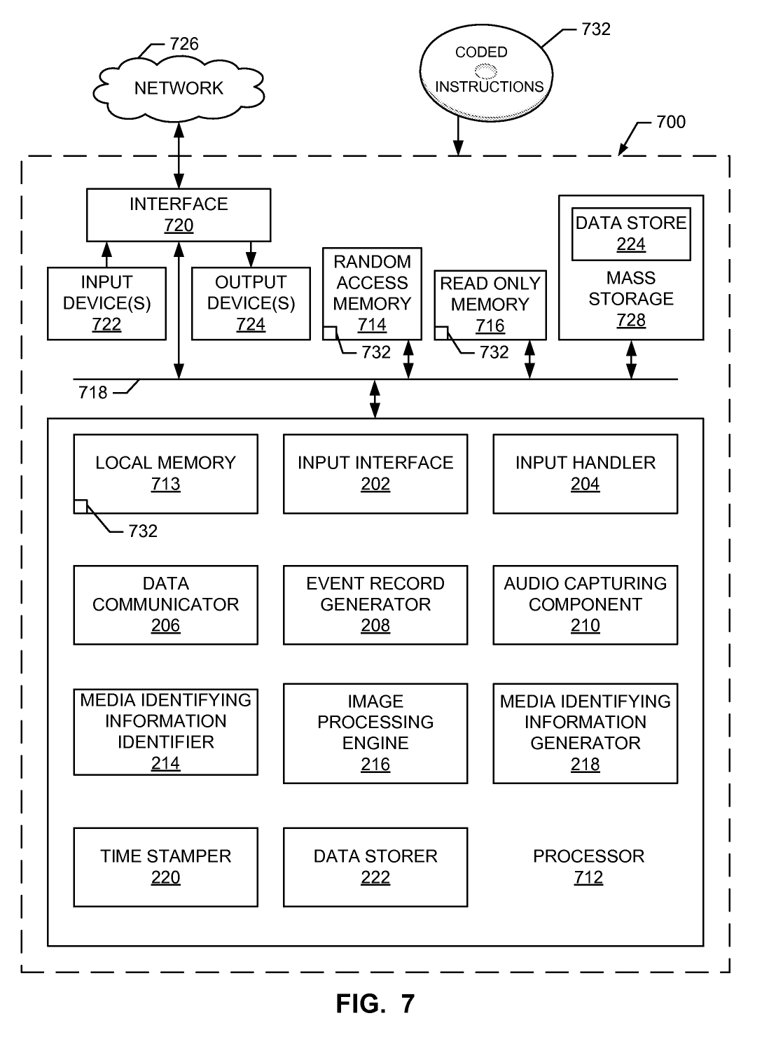

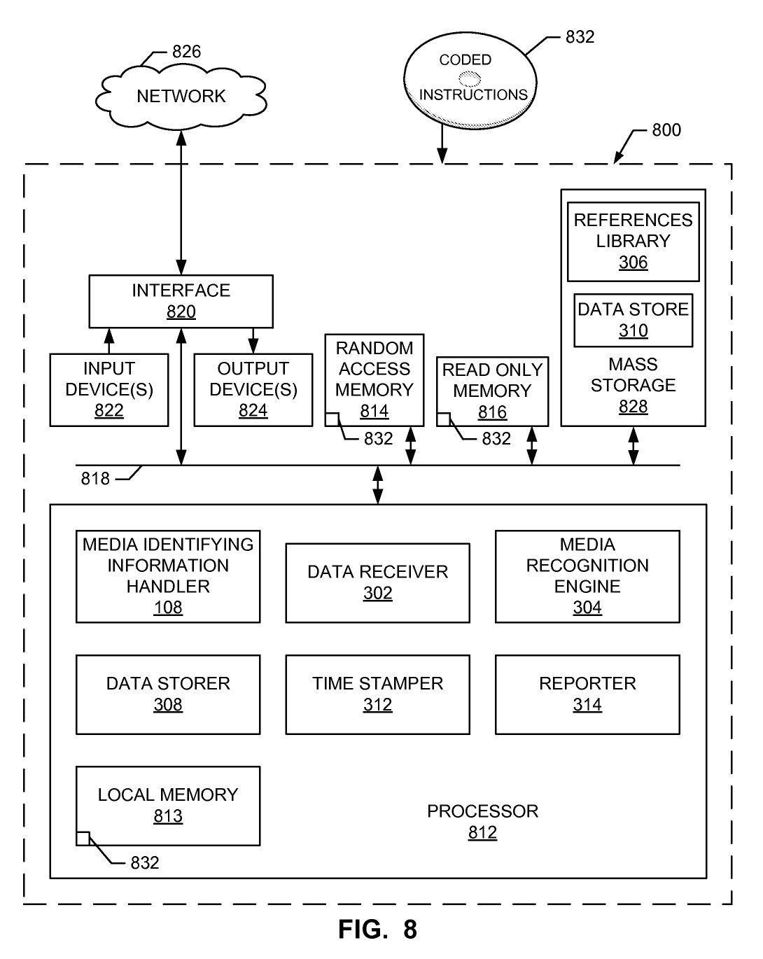

Flowcharts representative of example machine readable instructions for implementing the user control device meter 114 of FIGS. 1 and 2 are shown in FIGS. 4 and 5. A flowchart representative of example machine readable instructions for implement the audience measurement entity (AME) server 102 is shown in FIG. 6. In these examples, the machine readable instructions comprise programs for execution by a processor such as the processor 712 shown in the example user control device meter 700 discussed below in connection with FIG. 7 and/or the processor 812 shown in the example audience measurement entity server 800 discussed below in connection with FIG. 8. The programs may be embodied in software stored on a tangible computer readable storage medium such as a CD-ROM, a floppy disk, a hard drive, a digital versatile disk (DVD), a Blu-ray disk, or a memory associated with the processor 712 and/or the processor 812, but the entire programs and/or parts thereof could alternatively be executed by a device other than the processor 712 and/or the processor 812 and/or embodied in firmware or dedicated hardware. Further, although the example programs are described with reference to the flowcharts illustrated in FIGS. 4-6, many other methods of implementing the example user control device meter 114 and/or the example audience measurement entity (AME) server 102 may alternatively be used. For example, the order of execution of the blocks may be changed, and/or some of the blocks described may be changed, eliminated, or combined.

As mentioned above, the example processes of FIGS. 4-6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 4-6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The example program 400 of FIG. 4 begins at block 402 when the example user control device meter 114 (FIGS. 1 and 2) detects user activity. For example, the input handler 204 (FIG. 2) may obtain an input selection (e.g., via the input interface 202 (FIG. 2) included in the user control device meter 114) when the audience member 126 operates the user control device meter 114. At block 404, the example input handler 204 determines whether to generate an event record based on the obtained user activity. For example, the input handler 204 may check if the input selection is an intermediate input selection rather than a qualifying input selection. If, at block 404, the input handler 204 determined to generate an event record (e.g., the input selection was a qualifying input selection), then, at block 406, the input handler 204 causes the example event record generator 208 (FIG. 2) to generate an event record. For example, the event record generator 208 may associate audio data collected by the audio capturing component 210 (FIG. 2) and image data (e.g., an image 120 or a stream of images 120) captured by the image sensor 212 (FIG. 2) in the field of view 118 from the user control device meter 114. In some examples, the event record generator 208 may include the user activity information (e.g., input selection) determined by the input handler 204 in the generated event record.

If, at block 404, the input handler 204 determined not to initiate the event record generator 208 to generate an event record (e.g., the input selection was not a qualifying input selection), or after the event record generator 208 generates the event record at block 406, then, at block 408, the user control device meter 114 communicates the user activity for execution (e.g., transmit a signal to the media presentation device 110). For example, the input handler 204 may process the obtained input selection and communicate (e.g., via the infrared interface 207 example data communicator 206 (FIG. 2)) the processed input selection to the example media presentation device 110 (FIG. 1) and/or an accompanying device (e.g., a set top box (STB)) to change a channel tuned by the media presentation device 110 and/or an accompanying device, adjust the volume level of the media presentation device 110 and/or an accompanying device, select an input of the media presentation device 110 and/or an accompanying device, etc.

At block 410, the user control device meter 114 determines whether an event record was generated. For example, the example media identifying information identifier 214 (FIG. 2) may check the example data store 224 (FIG. 2) for unprocessed event records (e.g., event records where the media identifying information has not yet been identified). If, at block 410, the media identifying information identifier 214 determined an event record was generated and is unprocessed, then, at block 412, the media identifying information identifier 214 processes the event record. For example, the media identifying information identifier 214 may attempt to detect embedded media identifying information in the media or cause the media identifying information generator 218 (FIG. 2) to generate media identifying information. In the illustrated example, the operation of block 412 may be implemented using the process of FIG. 5.

If, at block 410, the media identifying information identifier 214 determined there were no unprocessed event records, or after the media identifying information identifier 214 processed the event records at block 412, then, at block 414, the user control device meter 114 determines whether to continue monitoring the media exposure site 104. For example, the user control device meter 114 may detect that the media presentation device 110 is OFF. If, at block 414, the user control device meter 114 determined to continue monitoring the media exposure site 104, then control returns to block 402 to wait to detect user activity. If, at block 414, the user control device meter 114 determined not to continue monitoring the media exposure site 104, then the example process 400 of FIG. 4 ends.

The example program 500 of FIG. 5 facilitates identifying media using image recognition by generating media identifying information (e.g., signatures, fingerprints, etc.) representative of the media captured in the image 120. The example program 500 may be used to implement block 412 of FIG. 4. At block 502, the example user control device meter 114 (FIGS. 1 and 2) obtains an event record to process. For example, the media identifying information identifier 214 (FIG. 2) may retrieve an event record from the data store 224 (FIG. 2). At block 504, the user control device meter 114 determines whether the event record includes embedded media identifying information. For example, the media may include a code/watermark that is collected by the audio capturing component 210 (FIG. 2) of the user control device meter 114. If, at block 504, the user control device meter 114 determined that the event record does not include embedded media identifying information (e.g., the media identifying information identifier 214 did not detect a code/watermark in the media), then, at block 506, the image processing engine 216 (FIG. 2) retrieves the image 120 associated with the event record from the data store 224. At block 508, the user control device meter 114 filters the image 120 associated with the event record. For example, the image processing engine 216 may remove unintended features (e.g., body parts, family portraits, etc.) identified in the image 120.

At block 510, the image processing engine 216 identifies the area of interest 124 representative of the media captured in the image 120. For example, the image processing engine 216 may identify patterns and/or shapes in the image 120 to identify the graphical user interface used to present the media. At block 512, the user control device meter 114 generates media identifying information representative of the media. For example, the example media identifying information generator 218 may use feature extraction and/or feature encryption to generate media identifying information (e.g., signatures, fingerprints, etc.) representative of the media based on the area of interest 124.

If, at block 504, the user control device meter 114 determined that the event record included a code/watermark, or after the user control device meter 114 generated media identifying information (e.g., signatures, fingerprints, etc.) at block 512, then, at block 514, the example data storer 222 (FIG. 2) records the media identifying information (e.g., the embedded media identifying information or the generated media identifying information) in the example data store 224. In some examples, the data storer 222 may include the user activity information included in the event record with the recorded media identifying information. At block 516, the data storer 222 appends a time stamp obtained from the example time stamper 220 (FIG. 2) to the recorded media identifying information. The example data storer 222 also appends a panelist identifier that uniquely identifies the panelist (e.g., an individual or a home) to the media identifying information recorded in the data store 224. In some examples, the data storer 222 appends a time stamp obtained from the example time stamper 220 to identify the media exposure time. At block 518, the user control device meter 114 discards the image 120 and/or portions of the image 120 not previously filtered and/or discarded during the image processing process (e.g., the area of interest 124). Control then returns to block 502 to wait to obtain another event record to process.

In some implementations, block 504 may not be included. For example, the user control device meter 114 may generate media identifying information (e.g., signatures, fingerprints, etc.) even if a code/watermark is detected.

The example program 600 of FIG. 6 illustrates an example method that may be executed by a computing device of an audience measurement entity to identify media. The example program 600 begins at block 602 when the example audience measurement entity (AME) server 102 obtains media identifying information. For example, the data receiver 302 (FIG. 3) may obtain media identifying information from the user control device meter 114 and/or the meter 112 (FIGS. 1 and 2) in one or more media exposure sites 104. At block 604, the AME server 102 compares the media identifying information to reference media identifying information corresponding to registered media. For example, the example media recognition engine 304 (FIG. 3) may compare a signature generated by the user control device meter 114 to reference signatures stored in the example references library 306 (FIG. 3). If, at block 606, the AME server 102 was unable to identify matching reference information, then, at block 608, the AME server 102 credits the media exposure to all other tuning data. For example, the example data storer 308 (FIG. 3) may log a media impression entry in the example data store 310 (FIG. 3). In some examples, the data storer 308 may append a time stamp obtained from the example time stamper 312 (FIG. 3) to indicate the date and/or time the media identifying information was received by the AME server 102. Control then proceeds to block 612 to determine whether there is additional media identifying information to process.

If, at block 606, the AME server 102 identified matching reference media identifying information in the references library 306, then, at block 610, the media recognition engine 304 credits the media corresponding to the media identifying information with an impression. The example data storer 308 records a media impression entry in the data store 310. In some examples, the data storer 308 may append a time stamp obtained from the example time stamper 312 to indicate the date and/or time the media identifying information was received by the AME server 102. In some examples, the media recognition engine 304 may apply quality of impression information to the media impression based on the user activity information included with the media identifying information.

At block 612, the AME server 102 determines whether continue identifying media. For example, the data receiver 302 may obtain additional media identifying information and/or the example data store 310 may include unprocessed media identifying information. If, at block 612, the AME server 102 determined to continue identifying media, then control returns to block 602 to obtain additional media identifying information.

If, at block 612, the AME server 102 determined not to continue identifying media, then, at block 614, the AME server 102 determines whether to generate a report. For example, the media provider 128 may want to compare the performances of distinct pieces of media they provide. If, at block 614, the AME server 102 determined to generate a report, then, at block 616, the example reporter 314 (FIG. 3) generates a report. For example, the report may identify different aspects of media usage such as, for example, how many impressions the distinct pieces of media received and demographics associated with those impressions.

If, at block 614, the AME server 102 determined not to generate a report, or after the reporter 314 generated a report at block 616, the example process 600 of FIG. 6 ends.

FIG. 7 is a block diagram of an example user control device meter 700 capable of executing the instructions of FIGS. 4 and/or 5 to implement the user control device meter 114 of FIGS. 1 and 2. The user control device meter 700 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The user control device meter 700 of the illustrated example includes a processor 712. The processor 712 of the illustrated example is hardware. For example, the processor 712 can be implemented by one or more integrated circuits, logic circuits, microprocessors or controllers from any desired family or manufacturer.

The processor 712 of the illustrated example includes a local memory 713 (e.g., a cache). The processor 712 of the illustrated example is in communication with a main memory including a volatile memory 714 and a non-volatile memory 716 via a bus 718. In the illustrated example, the processor 712 includes the example input interface 202, the example input handler 204, the example data communicator 206, the example infrared interface 207, the example event record generator 208, the example audio capturing component 210, the example image sensor 212, the example media identifying information identifier 214, the example image processing engine 216, the example media identifying information generator 218, the example time stamper 220 and the example data storer 222. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The user control device meter 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 720 of the illustrated example, thus, typically includes a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The user control device meter 700 of the illustrated example also includes one or more mass storage devices 728 for storing software and/or data. In the illustrated example, the mass storage device 728 includes the example data store 224. Examples of such mass storage devices 728 include floppy disk drives, hard drive disks, compact disk drives, Blu-ray disk drives, RAID systems, and digital versatile disk (DVD) drives.

The coded instructions 732 of FIGS. 4 and/or 5 may be stored in the mass storage device 728, in the volatile memory 714, in the non-volatile memory 716, and/or on a removable tangible computer readable storage medium such as a CD or DVD.

FIG. 8 is a block diagram of an example audience measurement entity server 800 capable of executing the instructions of FIG. 6 to implement the audience measurement entity (AME) server 102 of FIGS. 1 and/or 3. The audience measurement entity server 800 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The audience measurement entity server 800 of the illustrated example includes a processor 812. The processor 812 of the illustrated example is hardware. For example, the processor 812 can be implemented by one or more integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. In the illustrated example, the processor 812 includes the example media identifying information handler 108, the example data receiver 302, the example media recognition engine 304, the example data storer 308, the example time stamper 312 and the example reporter 314. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The audience measurement entity server 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The audience measurement entity server 800 of the illustrated example also includes one or more mass storage devices 828 for storing software and/or data. In the illustrated example, the mass storage device 828 includes the example references library 306 and the example data store 310. Examples of such mass storage devices 828 include floppy disk drives, hard drive disks, compact disk drives, Blu-ray disk drives, RAID systems, and digital versatile disk (DVD) drives.

The coded instructions 832 of FIG. 6 may be stored in the mass storage device 828, in the volatile memory 814, in the non-volatile memory 816, and/or on a removable tangible computer readable storage medium such as a CD or DVD.

From the foregoing, it will be appreciated that the above disclosed methods, apparatus and articles of manufacture facilitate identifying media presented at a media exposure site. Examples disclosed herein advantageously identify media even when media identifying information is not embedded in the media. For example, examples disclosed herein utilize a user control device including an image capture device to capture image(s) of media presented at the media exposure site, generate media identifying information (e.g., signatures, fingerprints, etc.) from the captured image(s) and compare the generated media identifying information to reference media identifying information corresponding to previously identified media. Examples disclosed herein are beneficial in reducing the amount of media characterized as “all other data.”

Examples disclosed herein reduce bandwidth usage between an on-device meter and an audience measurement entity and reduce processing demands for image analysis at the audience measurement entity as compared with metering systems that capture continuous video of a room. For example, the example on-device meter disclosed herein performs image analysis on captured images/videos and discards portions of the captured images/videos that are not identified as areas of interest (e.g., background portions, unintended features such as body parts, etc.) prior to generating media identifying information used to identify the corresponding media. Thus, the on-device meter protects sensitive user data. The disclosing also reduces the size of the image and/or video transmitted to the audience measurement entity to be used to generate media identifying information.

Moreover, examples disclosed herein enable collecting meaningful media exposure information. For example, the example on-device meter disclosed herein generates event record(s) when a moment of interest occurs. The moment of interest is detected when user activity corresponds with user exposure to media. For example, when the user (e.g., an audience member) operates the example on-device meter to control a media presentation device, the on-device meter generates an event record capturing image data of the media presented on the media presentation device. Accordingly, when the event record is processed, the corresponding media can be accurately credited with an exposure, as the user was actively engaging with the presentation of the media (e.g., was operating the remote control to control the media presentation device). Furthermore, by capturing an event record (e.g., including image data) at the moment of interest (and not capturing an event record at other times), the amount of processing resources needed for processing image and the bandwidth needed for transmitting event data to the AME is reduced (e.g., processing resources and bandwidth are not utilized for transmitting event data when a user is not present).

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to identify media comprising:
capturing an image of a media presentation device in response to an input selection to a user control device, the input selection to cause the user control device to control the media presentation device; and
in response to identifying an area of interest in the image, generating media identifying information representative of the media based on the identified area of interest.

2. A method as described in claim 1, wherein the user control device is a remote control that controls the media presentation device

3. A method as described in claim 1, wherein capturing the image includes capturing a stream of images.

4. A method as described in claim 1 further comprises processing the image to identify the area of interest in the image by:
identifying a first shape in the image via image recognition; and
comparing the first shape to a second shape included in a library of shapes.

5. A method as described in claim 4 further comprising identifying the first shape as the area of interest in the image when the first shape and the second shape satisfy a similarity threshold.

6. A method as described in claim 4 further comprising:
determining a third shape in the image and a fourth shape in the library of shapes satisfy a similarity threshold; and
discarding the third shape as an area of non-interest based on the fourth shape.

7. A method as described in claim 1, wherein generating the media identifying information comprises at least one of feature extraction or feature encryption of the area of interest.

8. A method as described in claim 1, wherein the input selection to control presentation of the media presentation device includes changing a channel, adjusting a volume level of the media presentation device or selecting an input of the media presentation device.

9. A method as described in claim 1, further comprising removing sensitive information from the image.

10. A remote control comprising:
an image sensor to capture an image of a media presentation device in response to an input selection, the input selection to cause the remote control to control the media presentation device;
an image processing engine to process the image to identify an area of interest in the image; and
a media identifying information generator to generate media identifying information representative of media included in the image based on the identified area of interest.

11. A remote control as described in claim 10, wherein the image sensor is to capture the image by capturing a stream of images in a burst.

12. A remote control as described in claim 10, wherein the image processing engine is to process the image to identify an area of interest in the image by:
using image recognition to identify a first shape in the image; and
comparing the first shape to a second shape included in a library of shapes.

13. A remote control as described in claim 12, wherein the image processing engine is to identify the first shape as the area of interest in the image when the first shape and the second shape satisfy a similarity threshold.

14. A remote control as described in claim 12, wherein the image processing engine is to:
determine a third shape in the image and a fourth shape in the library of shapes satisfy a similarity threshold; and
discard the third shape as an area of non-interest based on the fourth shape.

15. A remote control as described in claim 10, wherein the media identifying information generator is to generate the media identifying information by at least one of feature extraction or feature encryption of the area of interest.

16. A remote control as described in claim 10, wherein the input selection to control presentation of the media presentation device includes changing a channel, adjusting a volume level of the media presentation device or selecting an input of the media presentation device.

17. A tangible computer readable storage medium comprising instructions that, when executed, cause a processor to at least:
capture an image of a media presentation device in response to an input selection to a user control device, the input selection to cause the user control device to control the media presentation device; and
generate media identifying information representative of media included in the image based on the identified area of interest.

18. A tangible computer readable storage medium as defined in claim 17, wherein the user control device is a remote control that controls the media presentation device.

19. A tangible computer readable storage medium as defined in claim 17, wherein the instructions further cause the processor to capture the image by capturing a stream of images.

20. A tangible computer readable storage medium as defined in claim 17, wherein the instructions further cause the processor to process the image to identify an area of interest in the image by:
using image recognition to identify a first shape in the image; and
comparing the first shape to a second shape included in a library of shapes.

21. A tangible computer readable storage medium as defined in claim 20, wherein the instructions further cause the processor to identify the first shape as the area of interest in the image when the first shape and the second shape satisfy a similarity threshold.

22. A tangible computer readable storage medium as defined in claim 20, wherein the instructions further cause the processor to:
determine a third shape in the image and a fourth shape in the library of shapes satisfy a similarity threshold; and
discard the third shape as an area of non-interest based on the fourth shape.

23. A tangible computer readable storage medium as defined in claim 17, wherein the instructions further cause the processor to generate the media identifying information by at least one of feature extraction or feature encryption of the area of interest.

24. A tangible computer readable storage medium as defined in claim 17, wherein the input selection to control presentation of the media presentation device includes changing a channel, adjusting a volume level of the media presentation device or selecting an input of the media presentation device.
